(19) United States
(12) Patent Application Publication
(10) Pub. No.: US 2026/0202379 A1
(43) Pub. Date: Jul. 16, 2026

(54) MULTI-PURPOSE LOW-FREQUENCY EDDY CURRENT ARRAY (ECA)

(71) Applicant: Evident Canada, Inc., Québec (CA)

(72) Inventors: Benoit Lepage, L’Ancienne-Lorette (CA); Rémi Leclerc, Quebec City (CA)

(21) Appl. No.: 19/137,502

(22) PCT Filed: Dec. 22, 2023
(86) PCT No.: PCT/CA2023/051744

§ 371 Date: Jun. 10, 2025

Related U.S. Application Data
(60) Provisional application No. 63/477,655, filed on Dec. 29, 2022.

(51) Int. Cl. G01N 27/904; G01N 27/90

(52) U.S. Cl. CPC G01N 27/904; G01N 27/9006

(57) ABSTRACT

Configurations for sensor or coil assembly for performing eddy current (EC) testing are described. The sensor assembly can be fabricated using a printed-circuit board (PCB) construction, such as comprising a flex-circuit including dielectric and metallization layers. Adjacent coil elements can include an overlapping portion, where the currents of the overlapping portion cancel each other resulting in conceptually a larger coil, which can be used to support various reception or transmission configurations.

### CLAIM OF PRIORITY

This patent application claims the benefit of priority U.S. Provisional Patent Application Ser. No. 63/477,655, titled “MULTI-PURPOSE LOW-FREQUENCY EDDY CURRENT ARRAY (ECA),” filed on Dec. 29, 2022, which is hereby incorporated by reference herein in its entirety.

### TECHNICAL FIELD

This document pertains generally, but not by way of limitation, to apparatus and techniques for non-destructive inspection such as facilitating eddy current inspection, and more particularly, to apparatus and techniques for providing an Eddy Current Array (ECA) probe assembly comprising a printed circuit board (PCB) construction, such as comprising a flexible circuit.

### BACKGROUND

Non-destructive testing (NDT) can refer to use of one or more different techniques to inspect regions on or within an object, such as to ascertain whether flaws or defects exist, or to otherwise characterize the object being inspected. One class of non-destructive testing can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity. Generally, an eddy current (EC) sensor includes one or more sensor elements such as inductive coils that can be excited using an alternating current (AC) source. Such coils (or other electromagnetic sensing elements such as hall sensors) can be used for receiving a signal indicative of an induced eddy current on or within the structure.

### SUMMARY

Examples described herein relate to a coil array for eddy current (EC) inspection including a first coil and a second coil positioned adjacent to the first coil. A first portion of the first coil overlaps with a second portion of the second coil. The first portion of the first coil is configured to allow a first current to flow in a first direction, the second portion of the second coil is configured to allow a second current to flow in a second direction, and the first direction and the second direction are substantially opposite.

Examples described herein relate to a method for eddy current (EC) inspection comprising: providing a first coil; providing a second coil positioned adjacent to the first coil, wherein a first portion of the first coil overlaps with a second portion of the second coil; and activating the first coil and the second coil, wherein a first current associated with the first portion of the first coil flows in a first direction, a second current associated with the second portion of the second coil flows in a second direction, the first direction and the second direction are substantially opposite.

Examples described herein relate to a coil assembly for eddy current (EC) inspection including a first set of coil elements provided on a first set of one or more layers of a printed circuit board (PCB) and a second set of coil elements provided on a second set of one or more layers of the PCB. At least one coil element of the first set of coil elements overlaps with at least one coil element of the second set of coil elements in an overlapping portion.

### BRIEF DESCRIPTION OF THE DRAWINGS

The subject matter herein may be better understood by referring to the following description in conjunction with the accompanying drawings. The drawings are not meant to limit the scope of the claims included herewith. For clarity, not every element may be labeled in every figure. The drawings are not necessarily to scale, emphasis instead being placed upon illustrating examples, principles, and concepts. Thus, features and advantages of the present disclosure will become more apparent from the following detailed description of examples thereof taken in conjunction with the accompanying drawings in which:

FIG. 1A shows a simplified block diagram of example portions of a coil;

FIG. 1B shows a simplified block diagram of example portions of an overlapping coil configuration;

FIG. 1(C) shows a simplified tracing diagram of an example portion of an overlapping coil configuration;

FIGS. 2A-2H illustrate example portions of an overlapping coil configuration on multiple layers of a PCB;

FIG. 3 shows example portions of a coil assembly array with an overlapping coil configuration;

FIG. 4 illustrates an example coil configuration of the coil assembly array for detecting longitudinal defects; and

FIG. 5 illustrates an example coil configuration of the coil assembly array 300 for detecting transverse defects.

### DETAILED DESCRIPTION

Configurations for sensor or coil assembly for performing eddy current (EC) testing are described. The sensor assembly can be fabricated using a printed-circuit board (PCB) construction, such as comprising a flex-circuit including dielectric and metallization layers. The metallization layers can define or provide electrically connections to coil elements, and such elements can be operated by a multiplexer assembly for transmission and reception to support scanning related to different defect orientations. Adjacent coil elements can include an overlapping portion, where the currents of the overlapping portion cancel each other resulting in conceptually a larger coil, which can be used to support various reception or transmission configurations.

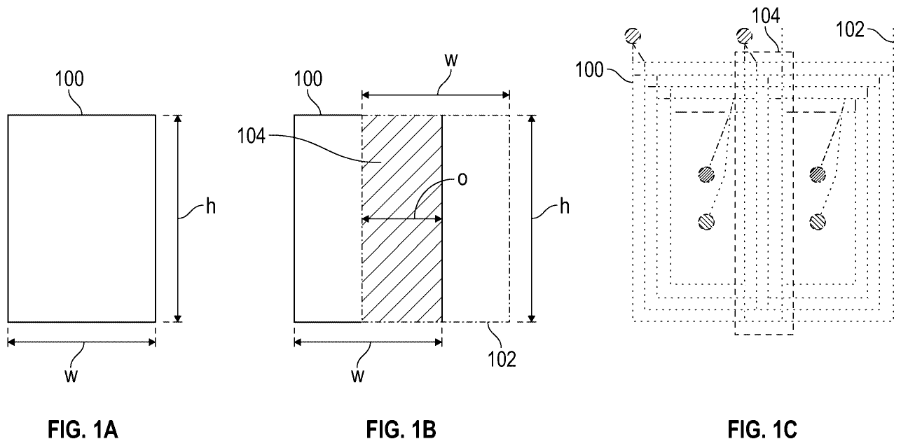

FIG. 1A shows a simplified block diagram of example portions of a coil 100. The coil 100 may have a width (w) parameter and a height (h) parameter. The coil 100 can include metallization layers, such as traces, and is configured to be used in EC testing. For example, coil 100 can be excited to generate electromagnetic energy for transmission into a test object, and the coil 100 can receive a resulting EC signal induced in the test object. For example, the EC signal can be used for detecting different types of defects in the test object.

In some conventional systems, a plurality of coils (or coil elements) are provided in an array. In these arrays, typically there is a space between adjacent coils. This space between adjacent coils can lead to less sensitivity for EC inspection.

FIG. 1B shows a simplified block diagram of example portions of an overlapping coil configuration. The overlapping coil configuration can include a first coil 100 and a second coil 102 with an overlapping portion 104. The first coil 100 and the second coil 102 may respective width (w) and height (h) parameters. In some examples, the first coil 100 and the second coil 102 may have the same width and height parameters

The first coil 100 and second coil 102 can be adjacent coils in an array, but with no space between the two coils. Instead, the two coils may overlap with the overlapping portion 104 having a width (o). The overlapping portion 104 can include one or more sets of traces belonging to the first coil 100 and one or more sets of traces belonging to the second coil 102. The orientation of the respective traces in the overlapping portion 104 may lead to opposing currents that cancel each other and create a response from substantially a larger coil without the overlapping portion, which is the combination of the first coil 100 and the second coil 102. The width of the larger coil may be represented as (w1)+(w2)−(o), where (w1) is the width of the first coil 100, (w2) is the width of the second coil 102, and (o) is the width of the overlapping portion. If the two coils have the same width, the width of the larger coil may be represented as 2(w)−(o).

FIG. 1(C) shows a simplified tracing diagram of an example portion of an overlapping coil configuration. The first coil 100 includes a plurality of traces. For example, the first coil 100 may include one or more sets of traces provided on one or more layers of a printed circuit board (PCB). The second coil 102 includes a plurality of traces. For example, the second coil 102 may include one or more sets of traces provided on one or more layers of the PCB. The overlapping portion 104 may include portions of the traces for the first coil 100 and portions of the traces for the second coil 102 so that current induced in the portions of traces for the first coil 100 are in the opposite direction than the current induced in the portions of traces for the second coil 102 in the overlapping portion 104. Hence, the overlapping portion 104 may not contribute to the induced EC signal (or transmission) from coils 100, 102, and the two coils 100, 102 may act substantially as one larger coil. In practical applications, during reception, little actual current may be flowing in the coils 100, 102 as the inputs may be a high impedance, but the coils are configured in such manner, as described herein, to act as a larger coil during reception with the overlapping portion 104 not contributing to the induced EC signal.

In some examples, the one or more sets of traces for the first coil 100 may be provided on a first set of one or more layers (two, four, eight, etc.) of the PCB while the one or more sets of traces for the second coil may be provided on a second set of one or more layers of the PCB.

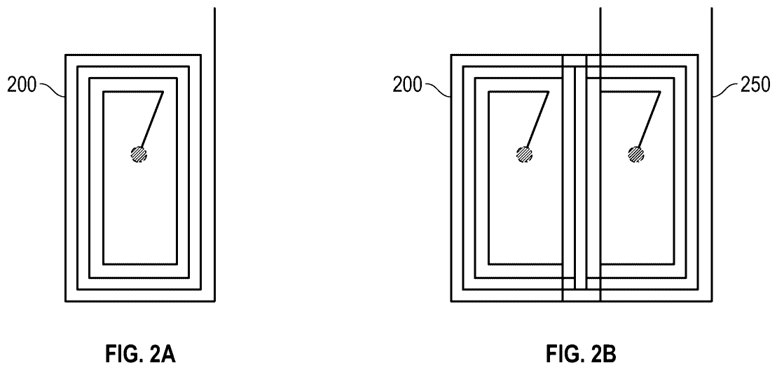

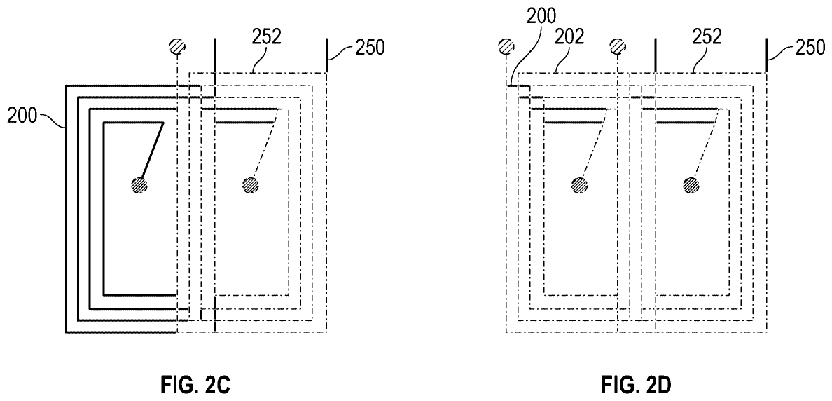

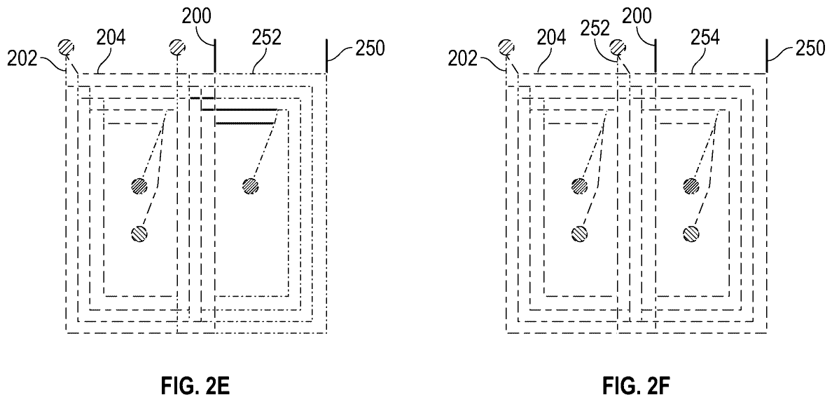

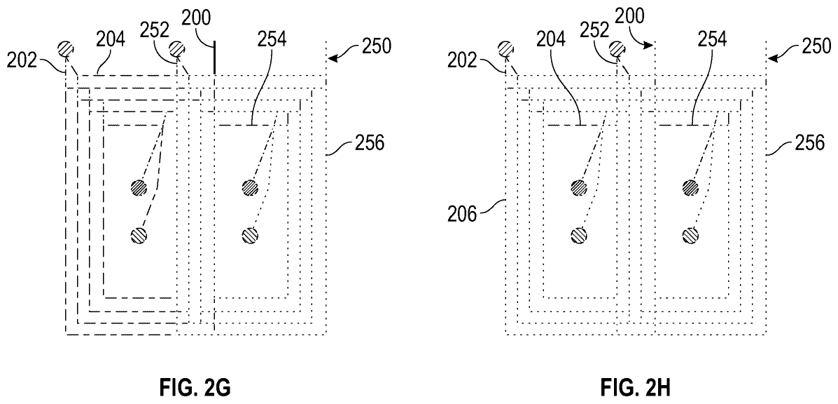

FIGS. 2A-2H illustrate example portions of an overlapping coil configuration on multiple layers of a PCB. Here, the PCB may include at least eight layers. The traces for the first coil 100 may be provided layers 1, 4, 5, and 8 of the PCB, and the traces for the second coil 102 may be provide layers 2, 3, 6, and 7 of the PCB, as described in further detail below.

As shown in FIG. 2A, a first set of traces 200 for a first coil (left coil) is provided (e.g., fabricated) on a first layer of a PCB.

As shown in FIG. 2B, a first set of traces 250 for a second coil (right coil) is provided on a second layer of the PCB. Portions of the first set of traces 200 for the left coil overlap with portions of the first set of traces 250 for the right coil in an overlapping portion. For example, the overlapping portions of the first set of traces 200 for the left coil are associated with a current flow in a first direction, and the overlapping portions of the first set of traces 250 for the right coil are associated with a current flow in a second direction, which is opposed to the first direction.

As shown in FIG. 2C, a second set of traces 252 for the right coil are provided on a third layer of the PCB. Portions of the second set of traces 252 for the right coil are provided in the overlapping portion.

As shown in FIG. 2D, a second set of traces 202 for the left coil are provided on a fourth layer of the PCB. Portions of the second set of traces 202 for the left coil are provided in the overlapping portion.

As shown in FIG. 2E, a third set of traces 204 for the left coil are provided on a fifth layer of the PCB. Portions of the third set of traces 204 for the left coil are provided in the overlapping portion.

As shown in FIG. 2F, a third set of traces 254 for right left coil are provided on a sixth layer of the PCB. Portions of the third set of traces 254 for the right coil are provided in the overlapping portion.

As shown in FIG. 2G, a fourth set of traces 256 for the right coil are provided on a seventh layer of the PCB. Portions of the fourth set of traces 256 for the right coil are provided in the overlapping portion.

As shown in FIG. 2H, a fourth set of traces 206 for the left coil are provided on an eight layer of the PCB. Portions of the fourth set of traces 206 for the left coil are provided in the overlapping portion.

Current flow for the sets of traces 200-206 in the overlapping portion for the left coil are in a first direction, and current flow for the sets of traces 250-256 for the right coil in the overlapping portion are in a second opposing direction so that the currents in the overlapping portion are canceled. Thus, the sets of traces 200-206, 250-256, when activated, can function as a larger coil for EC inspection for transmission and reception.

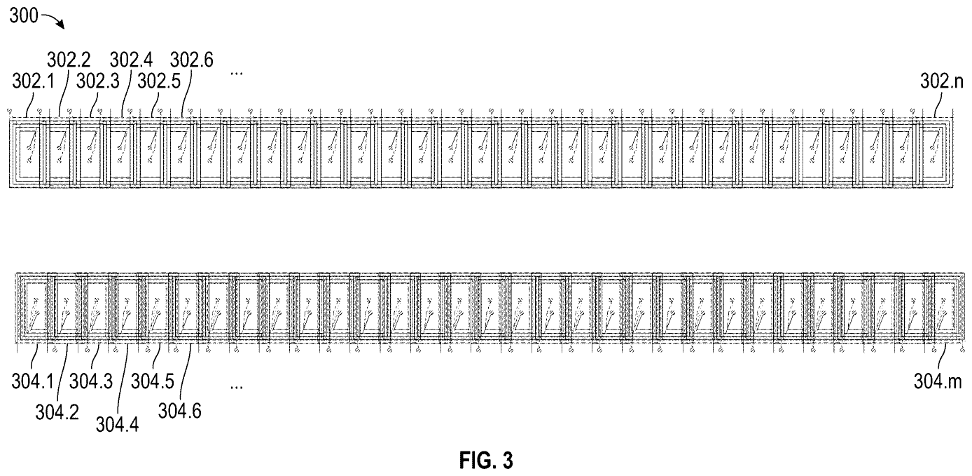

The overlapping coil configuration can be applied to coil assembly arrays. FIG. 3 shows example portions of a coil assembly array 300 with an overlapping coil configuration. The coil assembly array 300 may a include first row of coils 302.1-302.n (e.g., n=31 in this example). The coils 302.1-302.n may be provided in the overlapping coil configuration as described herein. For example, coil 302.1 may overlap with adjacent coil 302.2, and coil 302.2 may overlap with adjacent coil 302.3, and coil 302.3 may overlap with adjacent coil 302.4, and so on. The coils 302.1-302.n may be provided on multiples layers of a PCB. For example, odd numbered coils (302.1, 302.3, 302.5, . . . ) may be provided on a first set of layers of the PCB, and even numbered coils (302.2, 302.4, 302.6, . . . ) may be provided on a second set of layers of the PCB. With reference to the example described in FIGS. 2A-2H, the odd numbered coils (302.1, 302.3, 302.5, . . . ) may be provided on layers 1, 4, 5, and 8 of the PCB, and the even numbered coils (302.2, 302.4, 302.6, . . . ) may be provided on layers 2, 3, 6, and 7 of the PCB.

The coil assembly array 300 may include a second row of coils 304.1-304.n (e.g., n=31 in this example). The first row of coils and the second row of coils may be spaced apart by a distance(s). The coils 304.1-304.n may be provided in the overlapping coil configuration as described herein. For example, coil 304.1 may overlap with adjacent coil 304.2, and coil 304.2 may overlap with adjacent coil 304.3, and coil 304.3 may overlap with adjacent coil 304.4, and so on. The coils 304.1-304.n may be provided on multiples layers of a PCB. For example, odd numbered coils (304.1, 304.3, 304.5, . . . ) may be provided on a first set of layers of the PCB, and even numbered coils (304.2, 304.4, 304.6, . . . ) may be provided on a second set of layers of the PCB. With reference to the example described in FIGS. 2A-2H, the odd numbered coils (304.1, 304.3, 304.5, . . . ) may be provided on layers 1, 4, 5, and 8 of the PCB, and the even numbered coils (304.2, 304.4, 304.6, . . . ) may be provided on layers 2, 3, 6, and 7 of the PCB.

The coil assembly array 300 with the overlapping coil configuration can be used to perform EC inspection in different transmission and receiving configurations. The different configurations can be used to detect defects of different orientations. For example, the different configurations using the overlapping coil configuration can be used to detect longitudinal defects and transverse defects.

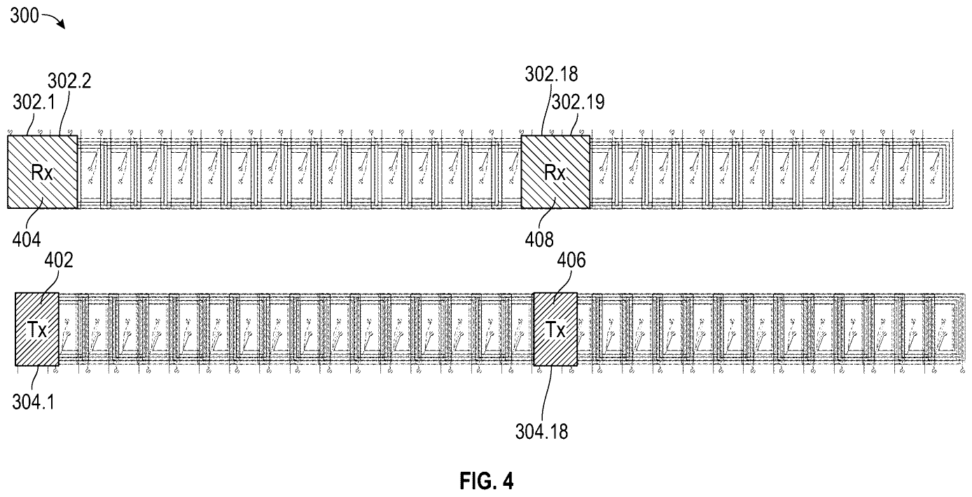

FIG. 4 illustrates an example coil configuration of the coil assembly array 300 for detecting longitudinal defects. In this example, coil 304.1 in the second row can be excited for transmission using a first transmission area 402 in a respective timeslot. The first transmission area 402 may include coil 304.1 to transmit a signal used for EC inspection. Coils 302.1, 302.2 in the first row may be activated for reception of the EC signal using a first reception area 404. The first reception area 404 may include coils 302.1, 302.2, which share an overlapping portion with opposing currents, so that the first reception area 404 may act as a larger coil comprising coils 302.1, 302.2 to improve sensitivity for EC inspection.

Additional sets of coils may also be used in the respective timeslot. In this example, coil 304.18 in the second row can be excited for transmission using a second transmission area 406 in the respective timeslot. The second transmission area 406 may include coil 304.18. Coils 302.18, 302.19 in the first row may be activated for reception of the EC signal using a second reception area 408. The second reception area 408 may include coils 302.18, 302.19, which share an overlapping portion with opposing currents, so that the second reception area 408 may act as a larger coil comprising coils 302.18, 302.19.

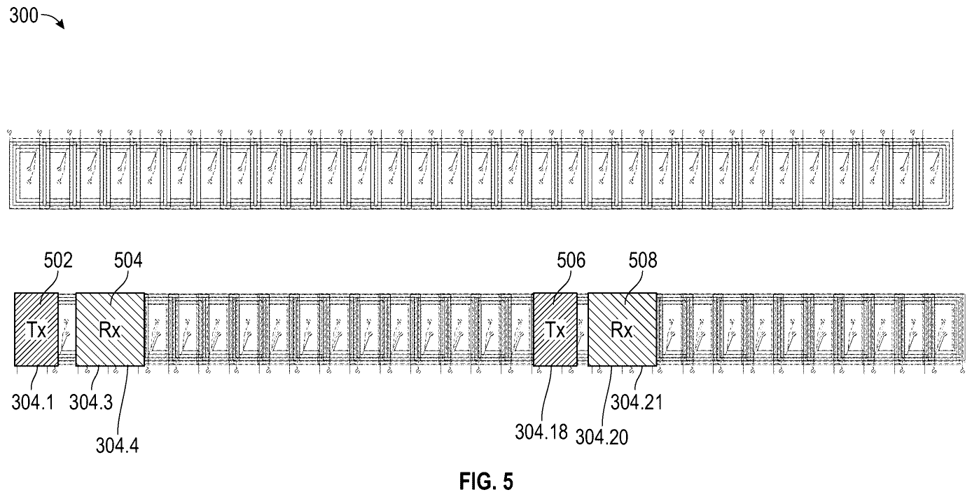

FIG. 5 illustrates an example coil configuration of the coil assembly array 300 for detecting transverse defects. In this example, coil 304.1 in the second row can be excited for transmission using a first transmission area 502 in a respective timeslot. The first transmission area 502 may include coil 304.1. Coils 304.3, 304.4 in the second row may be activated for reception of the EC signal using a first reception area 504. The first reception area 504 may include coils 304.3, 304.4, which share an overlapping portion with opposing currents, so that the first reception area 504 may act as a larger coil comprising coils 304.3, 304.4 to improve sensitivity for EC inspection.

Additional sets of coils may also be used in the respective timeslot. In this example, coil 304.18 in the second row can be excited for transmission using a second transmission area 506 in the respective timeslot. The second transmission area 506 may include coil 304.18. Coils 304.20, 304.21 in the second row may be activated for reception of the EC signal using a second reception area 508. The second reception area 508 may include coils 304.20, 304.21, which share an overlapping portion with opposing currents, so that the second reception area 508 may act as a larger coil comprising coils 304.20, 304.21 to improve sensitivity for EC inspection.

Processing (e.g., executing one or more of the methods described herein) may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information. The memory may include a machine readable medium on which is stored one or more sets of data structures or instructions (e.g., software) embodying or utilized by any one or more of the techniques or functions described herein.

In some embodiments, the system may be embodied by one or more programmable processors executing one or more computer programs to perform the functions of the system. In some other embodiments, all or part of the system may be implemented as special purpose logic circuitry (e.g., a field-programmable gate array (FPGA) and/or an application-specific integrated circuit (ASIC)). In some other embodiments, all or part of the system may be implemented using electronic hardware circuitry that include electronic devices such as, for example, at least one of a processor, a memory, a programmable logic device or a logic gate.

In one embodiment, the methods described herein are not limited to the specific examples described. In a further embodiment, rather, any of the method steps may be re-ordered, combined or removed, or performed in parallel or in serial, as necessary, to achieve the results set forth above.

In some embodiments, the system may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers)). In certain embodiments, each such program may be implemented in a high level procedural or object-oriented programming language to communicate with a computer system. In certain other embodiments, however, the programs may be implemented in assembly or machine language. In some embodiments, the language may be a compiled or an interpreted language and it may be deployed in any form, including as a stand-alone program or as a module, component, subroutine, or other unit suitable for use in a computing environment. In some other embodiments, a computer program may be deployed to be executed on one computer or on multiple computers at one site or distributed across multiple sites and interconnected by a communication network.

The methods and apparatus of this disclosure may take the form, at least partially, of program code (i.e., instructions) embodied in tangible non-transitory media, such as floppy diskettes, CD-ROMs, hard drives, random access or read only-memory, or any other machine-readable storage medium.

When the program code is loaded into and executed by a machine, such as the computer of FIG. 4, the machine becomes an apparatus for practicing examples of the present subject matter. When implemented on one or more general-purpose processors, the program code combines with such a processor to provide a unique apparatus that operates analogously to specific logic circuits. As such, a general purpose digital machine can be transformed into a special purpose digital machine. In some other embodiment, a non-transitory machine-readable medium may include but is not limited to a hard drive, compact disc, flash memory, non-volatile memory, volatile memory, magnetic diskette and so forth but does not include a transitory signal per se.

The term “machine readable medium” or “machine readable storage medium” may include any medium that is capable of storing, encoding, or carrying instructions for execution by a machine and that cause the machine to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

Although the foregoing examples have been described in some detail for purposes of clarity of understanding, it will be apparent that certain changes and modifications may be practiced within the scope of the appended claims. The scope of the invention is limited only by the claims and the invention encompasses numerous alternatives, modifications, and equivalents. Numerous specific details are set forth in the above description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Accordingly, the above implementations are to be considered as illustrative and not restrictive, and the invention is not to be limited to the details given herein, but may be modified within the scope and equivalents of the appended claims.

Various embodiments of the present disclosure have been described with reference to the accompanying drawings. It may be appreciated that these example embodiments are provided only for enabling those skilled in the art to better understand and then further implement the present disclosure and not intended to limit the scope of the present disclosure in any manner. It should be noted that these drawings and description are only presented as examples of embodiments and, based on this description, alternative embodiments may be conceived that may have a structure and method disclosed as herein, and such alternative embodiments may be used without departing from the principle of the disclosure as claimed in the present disclosure.

It may be noted that the flowcharts and block diagrams in the figures may illustrate the apparatus, method, as well as architecture, functions and operations executable by a computer program product according to various embodiments of the present disclosure. In this regard, each block in the flowcharts or block diagrams may represent a module, a program segment, or a part of code, which may contain one or more executable instructions for performing specified logic functions. It should be further noted that, in some alternative implementations, functions indicated in blocks may occur in an order differing from the order as illustrated in the figures. For example, two blocks shown consecutively may be performed in parallel substantially or in an inverse order sometimes, which depends on the functions involved. It should be further noted that each block and a combination of blocks in the block diagrams or flowcharts may be implemented by a dedicated, hardware-based system for performing specified functions or operations or by a combination of dedicated hardware and computer instructions.

The terms “comprise(s),” “include(s)”, their derivatives, and like expressions used herein should be understood to be open (i.e., “comprising/including, but not limited to”). The term “based on” means “at least in part based on”, the term “one embodiment” means “at least one embodiment”, and the term “another embodiment” indicates “at least one further embodiment”. Relevant definitions of other terms have been provided.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description as examples or implementations, with each claim standing on its own as a separate implementation, and it is contemplated that such implementations can be combined with each other in various combinations or permutations. The scope of the invention should be determined with reference to the appended claims, along with the full scope of equivalents to which such claims are entitled.

What is claimed is:

1. A coil array for eddy current (EC) inspection, comprising:
a first coil; and
a second coil positioned adjacent to the first coil;
wherein a first portion of the first coil overlaps with a second portion of the second coil, and
wherein the first portion of the first coil is configured to allow a first current to flow in a first direction, the second portion of the second coil is configured to allow a second current to flow in a second direction, and the first direction and the second direction are substantially opposite.

2. The coil array of claim 1, wherein the first coil includes a first set one or more traces provided in a first set of one or more layers of a printed circuit board (PCB), wherein the second coil includes a second set of one or more traces provided in a second set of one or more layers of the PCB.

3. The coil array of claim 1, further comprising:
a third coil positioned adjacent to the second coil,
wherein a third portion of the third coil overlaps with a fourth portion of the second coil, and
wherein the third portion of the third coil is configured to allow a third current to flow in the first direction.

4. The coil array of claim 1, wherein:
a first set of traces for the first coil are provided on a first layer of a printed circuit board (PCB); and
a first set of traces for the second coil are provided on a second layer of the PCB.

5. The coil array of claim 4, wherein:
a second set of traces for the second coil are provided on a third layer of the PCB; and
a second set of traces for the first coil are provided on a fourth layer of the PCB.

6. The coil array of claim 5, wherein:
a third set of traces for the first coil are provided on a fifth layer of the PCB; and
a third set of traces for the second coil are provided on a sixth layer of the PCB.

7. The coil array of claim 6, wherein:
a fourth set of traces for the second coil are provided on a seventh layer of the PCB; and
a fourth set of traces for the second coil are provided on an eight layer of the PCB.

8. The coil array of claim 1, wherein the first coil and the second coil are configured to be activated together to operate substantially as a larger coil for reception of an EC signal.

9. The coil array of claim 1, wherein the first coil and the second coil are configured to transmit at least one signal used for EC inspection together operating substantially as a larger coil.

10. A method for eddy current (EC) inspection comprising:
providing a first coil;
providing a second coil positioned adjacent to the first coil, wherein a first portion of the first coil overlaps with a second portion of the second coil; and
activating the first coil and the second coil, wherein a first current associated with the first portion of the first coil flows in a first direction, a second current associated with the second portion of the second coil flows in a second direction, the first direction and the second direction are substantially opposite.

11. The method of claim 10, wherein the first coil includes a first set one or more traces provided in a first set of one or more layers of a printed circuit board (PCB), wherein the second coil includes a second set of one or more traces provided in a second set of one or more layers of the PCB.

12. The method of claim 10, further comprising:
providing a third coil positioned adjacent to the second coil, wherein a third portion of the third coil overlaps with a fourth portion of the second coil;
activating the third coil, wherein a third current associated with a third portion of the third coil flows in the first direction.

13. The method of claim 10, wherein:
a first set of traces for the first coil are provided on a first layer of a printed circuit board (PCB); and
a first set of traces for the second coil are provided on a second layer of the PCB.

14. The method of claim 13, wherein:
a second set of traces for the second coil are provided on a third layer of the PCB; and
a second set of traces for the first coil are provided on a fourth layer of the PCB.

15. The method of claim 14, wherein:
a third set of traces for the first coil are provided on a fifth layer of the PCB; and
a third set of traces for the second coil are provided on a sixth layer of the PCB.

16. The method of claim 15, wherein:
a fourth set of traces for the second coil are provided on a seventh layer of the PCB; and
a fourth set of traces for the second coil are provided on an eight layer of the PCB.

17. The method of claim 10, wherein the first coil and the second coil are activated together for operating substantially as a larger coil for reception of an EC signal.

18. The method of claim 1, wherein the first coil and the second coil are activated together to transmit at least one signal used for EC inspection operating substantially as a larger coil.

19. A coil assembly for eddy current (EC) inspection:
a first set of coil elements provided on a first set of one or more layers of a printed circuit board (PCB);
a second set of coil elements provided on a second set of one or more layers of the PCB,
wherein at least one coil element of the first set of coil elements overlaps with at least one coil element of the second set of coil elements in an overlapping portion.

20. The coil assembly of claim 19, wherein portion of the at least one coil element of the first set of coil elements and portion of the at least one coil element of the second set of coil elements in the overlapping portion are configured to generate opposing currents.
